(19) United States
(12) Patent Application Publication
(10) Pub. No.: US 2026/0050698 A1
(43) Pub. Date: Feb. 19, 2026

(54) Data encryption using electrical signals generated by a piezoelectric device

(71) Applicant: Bank of America Corporation, Charlotte, NC (US)

(72) Inventors: Adam King, Fort Mill, SC (US); Stacy Ellis Ingle, Denver, NC (US)

(21) Appl. No.: 18/807,151

(22) Filed: Aug. 16, 2024

(51) Int. Cl. G06F 21/83

(52) U.S. Cl. CPC G06F 21/83

(57) ABSTRACT

An electronic device detects that an electrical signal was generated by a piezoelectric material that is configured to generate the electrical signal when mechanical stress is applied to the piezoelectric material. The electronic device generates an encryption key based on the electrical signal generated by the piezoelectric material. In response to receiving a request to transmit data, the electronic device encrypts the requested data based on the encryption key to generate encrypted data and transmits the encrypted data.

### TECHNICAL FIELD

The present disclosure relates generally to network communication, and more specifically to data encryption using electrical signals generated by a piezoelectric device.

### BACKGROUND

Often data transmission links and networks used to transmit sensitive data are prone to cyber-attacks that may lead to data theft. For example, a bad actor may gain access to a data link or a data network used for transmission of the sensitive data and steal sensitive data transiting the link or network. Present systems are not equipped to effectively avoid and/or prevent theft of sensitive data.

### SUMMARY

The system and method implemented by the system as disclosed in the present disclosure provide technical solutions to the technical problems discussed above by avoiding theft of sensitive data (e.g., as a result of cyber-attacks) in a computing network.

For example, the disclosed system and methods provide the practical application of generating an encryption key based at least in part upon random or pseudo-random electrical signals generated by a piezoelectric material and encrypting data using the encryption key. As described in accordance with embodiments of the present disclosure an electronic device may house a piezoelectric material that is configured to convert mechanical stimuli into an electrical signal, wherein the electrical signal is a function of variations in pressure (e.g., mechanical stress) applied by the mechanical stimuli to the piezoelectric material. The electronic device generates an encryption key based on the electrical signal generated by the piezoelectric material, wherein the encryption key is also a function of the variations in pressure (e.g., mechanical stress) associated with the mechanical stimuli used to generate the electrical signal. The electronic device may encrypt a piece of data using the encryption key to generate encrypted data and then transmit the encrypted data to another computing node.

The dynamic nature of the encryption keys generated by the electronic device helps improve data security and avoids data theft. For example, the electronic device may encrypt different pieces of data transmitted by the electronic device using different encryption keys, wherein each encryption key is generated based on a different electrical signal which in turn is a function of a different stimulus applied to the piezoelectric material. The dynamically changing nature of the encryption keys may make it difficult for a bad actor to determine an encryption key applied to a particular piece of data. For example, by the time a bad actor is able to reverse engineer a particular piece of data to determine the encryption key used to encrypt the particular piece of data, the electronic device may have already changed the encryption key used to encrypt subsequent pieces of data. Further, since each encryption key is a function of a random electrical signal, a bad actor may not determine a pattern of the changing encryption keys. This further avoids the bad actor from deciphering the encryption keys. Thus, the disclosed system and method improve data security of a data network and generally improve the technology related to data networks.

The disclosed system and method provide an additional practical application of powering the electronic device based on electrical power/energy generated by the piezoelectric material. As described in embodiments of the present disclosure, surplus electrical power generated by the piezoelectric material may be stored in a battery and may be used to power electrical and electronic components of the electronic device such as a processor and a memory used to implement the data security methods discussed in this disclosure. Storing surplus electrical power in the battery of the electronic device lengthens the usable battery life of the battery before it needs charging or replacement. This means that the processor and memory of the electronic device may be operated longer, thus increasing the amount of data that may be processed by the processor. This improves the processing efficiency of the processor.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure; and

FIG. 2 illustrates a flowchart of an example method for encrypting data, in accordance with one or more embodiments of the present disclosure.

### DETAILED DESCRIPTION

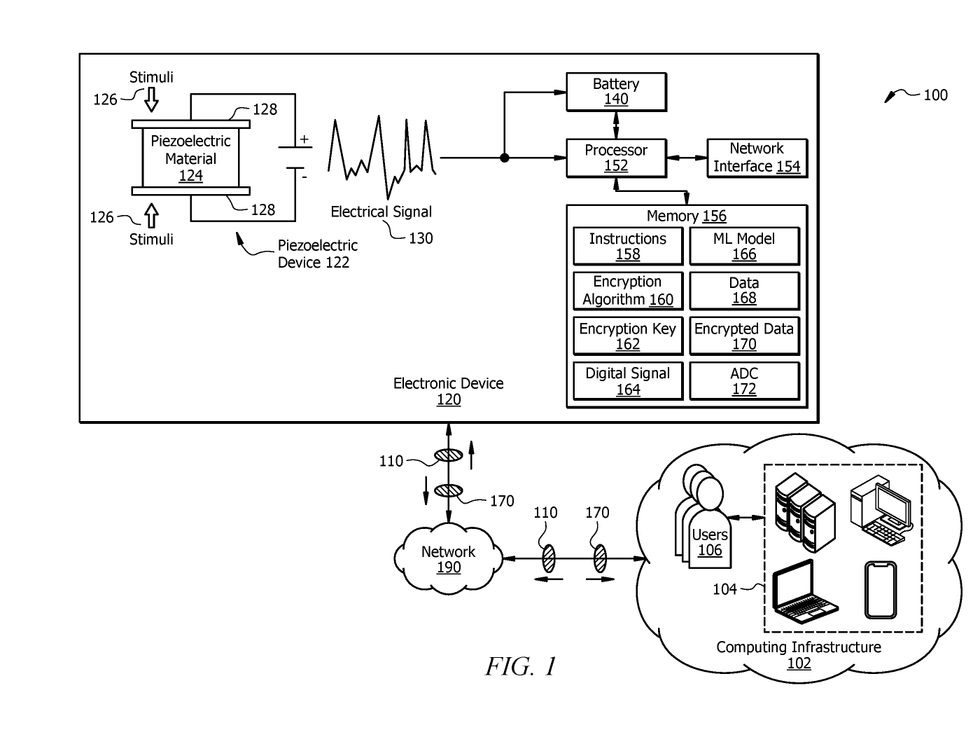

FIG. 1 is a schematic diagram of a system 100, in accordance with certain aspects of the present disclosure. As shown, system 100 includes a computing infrastructure 102 and an electronic device 120 connected to a network 190. Computing infrastructure 102 may include a plurality of hardware and software components. The hardware components may include, but are not limited to, computing nodes 104 such as desktop computers, smartphones, tablet computers, laptop computers, servers and data centers, mainframe computers, virtual reality (VR) headsets, augmented reality (AR) glasses and other hardware devices such as printers, routers, hubs, switches, and memory all connected to the network 190. Software components may include software applications that are run by one or more of the computing nodes 104 including, but not limited to, operating systems, user interface applications, third party software, database management software, service management software, mainframe software, metaverse software, AI tools and other customized software programs implementing particular functionalities. For example, software code relating to one or more software applications may be stored in a memory device and one or more processors (e.g., belonging to one or more computing nodes 104) may execute the software code to implement respective functionalities. In one embodiment, at least a portion of the computing infrastructure 102 may be representative of an Information Technology (IT) infrastructure of an organization.

One or more of the computing nodes 104 may be operated by a user 106. In this context, a computing node 104 operated by a user 106 may be referred to as a user device. For example, a computing node 104 may provide a user interface using which a user 106 may operate the computing node 104 to perform data interactions within the computing infrastructure 102. The term “computing node 104” may be replaced by “user device” in this disclosure when the computing node 104 is operated by a user 106.

One or more computing nodes 104 of the computing infrastructure 102 may be representative of a computing system which hosts software applications that may be installed and run locally or may be used to access software applications running on a server. The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality as described below. In certain embodiments, one or more of the computing nodes 104 may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

The electronic device 120 may be any computing device that is capable of storing, processing, and exchanging data (e.g., data 168) with other computing nodes 104. In one embodiment, the electronic device 120 may include a smart wearable device such as smart watch, fitness wristband, activity tracker, smart eyeglass, a wearable fitness device or any other smart wearable device. In alternative or additional embodiments, the electronic device 120 may include a portable computing device such as a smartphone, tablet computer, or laptop computer. In one embodiment, the electronic device 120 may be one of the computing nodes 104 of the computing infrastructure 102 and may be configured to be operable by a user 106.

In some cases, the electronic device 120 may need to transmit data 168 to another device (e.g., a particular computing node 104 of the computing infrastructure 102). For example, a wearable device (e.g., a smart watch, fitness device etc.) may be configured to periodically upload to a server, fitness related data associated with a user 106 who wears the electronic device 120. In some embodiments, a user 106 may operate the electronic device 120 to perform a data interaction within the computing infrastructure 102 and data 168 associated with the data interaction may be transmitted to one or more computing nodes 104 of the computing infrastructure 102. For example, the user 106 may use a mail application running on the electronic device 120 to send an email to another user device (e.g., a computing node 104) of the computing infrastructure 102. In some cases, data 168 transmitted by the electronic device 120 may include sensitive data including, but not limited to, Non-Public Information (NPI), Personal Identification Information (PII), Production Information, or any other data that is designated as sensitive data.

Often, data networks (e.g., network 190) used to transmit sensitive data are prone to cyber-attacks that may lead to data theft. For example, a bad actor may gain access to the data network (e.g., network 190) and steal sensitive data transiting the network between the electronic device 120 and another computing node 104 of the computing infrastructure 102. Present systems are not equipped to effectively avoid and/or prevent theft of sensitive data.

Embodiments of the present disclosure describe techniques to avoid theft of sensitive data (e.g., as a result of cyber-attacks) in a computing network (e.g., computing infrastructure 102).

In one or more embodiments, as further described below, the electronic device 120 may implement techniques that avoid data theft in a computing network (e.g., computing infrastructure 102). As shown in FIG. 1, the electronic device 120 includes a piezoelectric device 122, a processor 152, a memory 156, a network interface 154, and a battery 140. The electronic device 120 may be configured as shown in FIG. 1 or in any other suitable configuration.

The piezoelectric device 122 includes (e.g., houses) a piezoelectric material 124 that converts stimuli 126 to electrical power. The stimuli 126 may include mechanical stress such as vibrations or shocks, heat changes, sound waves, movements, any other suitable application of force upon the piezoelectric material 124, or any combination thereof. Essentially, the piezoelectric device 122 converts ambient stimuli 126 (e.g., mechanical vibrations as a result of user interactions with the electronic device 120) into electrical energy. In one embodiment, the piezoelectric device 122 includes the piezoelectric material 124 between two metal plates, such as electrodes 128, that collect the electric energy generated by the piezoelectric material 124. When pressure or forces are applied to the electrodes 128, the electric charges within the piezoelectric material 124 are forced out of balance, which creates the electrical power/energy. The electrical power/energy generated by the piezoelectric device 122 is represented by an electrical signal 130. In one embodiment, the piezoelectric material 124 includes cellulose nanocrystals. However, it may be noted that any piezoelectric material 124 having piezoelectric properties may be used. For example, the piezoelectric material 124 may include, but is not limited to, ceramics such lead zirconate titanate (PZT), barium titanate, and lead titanate, natural materials such as quartz, topaz, tourmaline, Rochelle salt, silk, wood, rubber, dentin, bone, hair, and enamel, manmade materials such as polymers and composite-based materials, or a combination thereof.

It may be noted that certain embodiments of the present disclosure are described in the context of the electrical signal 130 generated by application of mechanical stimuli (e.g., mechanical stress, vibrations, and/or shocks) to the piezoelectric material 124. However, a person having ordinary skill in the art may appreciate that these embodiments apply to generation of an electrical signal 130 by application of any stimuli 126 (e.g., mechanical, heat, sound, movements etc.) or a combination of different types of stimuli 126.

The processor 152 includes one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

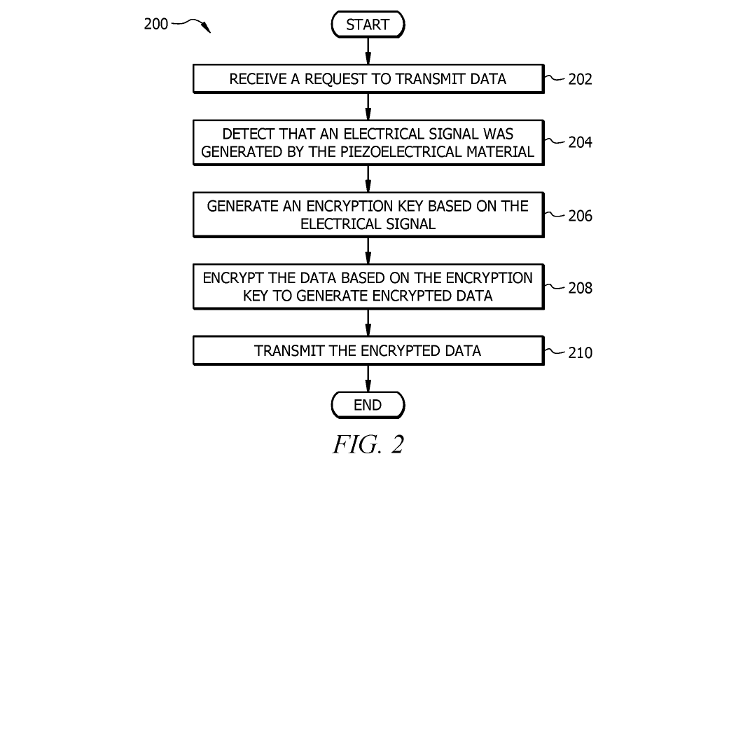

The one or more processors are configured to implement various instructions, such as software instructions. For example, the one or more processors are configured to execute instructions 158 to implement one or more data encryption techniques disclosed herein. In this way, processor 152 may be a special-purpose computer designed to implement the functions disclosed herein. In one or more embodiments, the electronic device 120 is implemented using logic units, FPGAs, ASICs, DSPs, or any other suitable hardware. The electronic device 120 is configured to operate as described with reference to FIG. 2. For example, the processor 152 may be configured to perform at least a portion of method 200 s described with reference to FIG. 2.

The memory 156 includes a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may include a read-only memory (ROM), random-access memory (RAM), ternary content-addressable memory (TCAM), dynamic random-access memory (DRAM), and static random-access memory (SRAM).

The memory 156 is operable to store the instructions 158, one or more encryption algorithms 160, encryption key 162, digital signal 164, data 168, one or more machine learning (ML) models 166, ADC 172, and any other data needed to performed operations of the electronic device 120 as described in embodiments of the present disclosure. The instructions 158 may include any suitable set of instructions, logic, rules, or code operable to execute the electronic device 120.

The network interface 154 is configured to enable wired and/or wireless communications. The network interface 154 is configured to communicate data between the electronic device 120 and other devices, systems, or domains (e.g., computing nodes 104). For example, the network interface 154 may include a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

The battery 140 may be configured to power the electronic device 120. For example, the battery 140 may provide electric power to the processor 152, the network interface 154, the memory 156 and any other electric or electronic component of the electronic device 120. In one embodiment, at least a portion of the electric power (shown as electrical signal 130) may be stored in the battery 140 and used to at least partially power the electronic device 120.

It may be noted that each of the computing nodes 104 may be implemented like the electronic device 120 shown in FIG.1. For example, each of the computing nodes 104 may have a respective processor and a memory that stores data and instructions to perform a respective functionality of the computing node 104.

In one or more embodiments, the electronic device 120 may be configured to generate an encryption key 162 based on an electrical signal 130 generated by the piezoelectric device 122. The encryption key 162 may then be used to encrypt data 168 configured to be transmitted by the electronic device 120. As described above, the piezoelectric material 124 coverts stimuli 126 into electrical energy represented as the electrical signal 130. For example, a mechanical stimulus 126 (e.g., mechanical stress, vibrations, movements, shock etc.) as a result of an interaction of the electronic device 120 with its environment (e.g., interaction with a user of the electronic device 120) may cause the piezoelectric material 124 to generate an electrical signal 130. By nature, the electrical signal 130 is a function of the stimuli 126 applied to the piezoelectric material 124. For example, the electrical signal 130 is a function of the mechanical stimulus 126 applied to the piezoelectric material 124. This means that the amount of the mechanical stimulus 126 and frequency with which the mechanical stimulus 126 is applied to the piezoelectric material 124 decides the waveform (e.g., amplitude and frequency) of the electrical signal 130 over time. For example, 0 volts is registered when no mechanical stimulus 126 is applied to the piezoelectric material 124 and a positive voltage is registered when mechanical stimulus 126 is applied. Additionally, larger amounts (e.g., higher intensity) of mechanical stimulus 126 results in higher amplitude peaks for the electrical signal 130.

In one or more embodiments, the electronic device 120 may be configured to convert an electrical signal 130 generated by the piezoelectric device 122 into a digital signal 164. Since the electrical signal 130 is a function of the stimuli 126 applied to the piezoelectric material 124, the digital signal 164 generated based on the electrical signal 130 is indirectly also a function of the stimuli 126 applied to the piezoelectric material 124. As the stimuli 126 applied to the piezoelectric material 124 is usually random depending on random interactions of the electronic device 120 with its environment, the electrical signal 130 which is a function of the stimuli 126 is also random, and the digital signal 164 generated based on the electrical signal 130 is in turn also random. As described further below, the electronic device 120 may generate an encryption key 162 based on the digital signal 164. Since digital signals 164 generated based on different electrical signals 130 may be random as a result of the respective stimuli 126 applied to the piezoelectric material 124 being random, the encryption key 162 generated based on different digital signals 164 are also different. In other words, encryption keys 162 generated based on different electrical signals 130 generally do not match. The dynamic nature of the encryption keys 162 generated by the electronic device 120 helps improve data security and avoids data theft. For example, the electronic device 120 may encrypt different pieces of data 168 transmitted by the electronic device 120 using different encryption keys 162, wherein each encryption key 162 is generated based on a different electrical signal 130 which in turn is a function of a different stimulus 126 applied to the piezoelectric material 124. The dynamically changing nature of the encryption keys 162 may make it difficult for a bad actor to determine an encryption key 162 applied to a particular piece of data 168. For example, by the time a bad actor is able to reverse engineer a particular piece of data 168 to determine the encryption key 162 used to encrypt the particular piece of data 168, the electronic device 120 may have already changed the encryption key 162 used to encrypt subsequent pieces of data 168. Further, since each encryption key 162 is a function of a random electrical signal 130, a bad actor may not determine a pattern of the changing encryption keys 162. This further avoids the bad actor from deciphering the encryption keys 162.

The electronic device 120 may use any known technique to convert the analog electrical signal 130 into a digital signal 164. For example, the electronic device 120 may implement an analog to digital converter (ADC) 172 that converts an analog electrical signal 130 into a digital signal 164 containing a stream of binary digits (e.g., 0s and 1s) that represent the analog electrical signal 130. Like any typical analog to digital converter, the ADC 172 may perform the steps of sampling, quantization and encoding to convert the analog electrical signal 130 into a corresponding digital signal 164. Sampling in an analog-to-digital converter refers to the process of taking samples of a continuous analog signal at specific points in time to convert it into a discrete digital signal. Quantization in an analog-to-digital converter is the process of converting a continuous analog signal into a discrete digital value. During this process, each sampled value is matched with the closest value from a limited number of discrete levels, or quantization levels. The number of quantization levels is determined by the quantization resolution, which is expressed in bits. For example, a 1-bit quantizer can translate the sampled values of the analog signal into 2 different levels, each level represents a particular amplitude value (e.g., voltage) of the signal. For example, a first level may represent 0 volts(V) or near 0V and the second level may represent 5V or near 5V. A 2-bit quantizer can translate the sampled values of the analog signal into 4 different levels, wherein each of the 4 levels represent a distinct amplitude value (e.g., voltage) of the signal. Encoding in analog-to-digital converters is the process of converting quantized signals into a digital representation. This is done by assigning a unique label (e.g., a binary word) to each quantization level. For example, for a 1-bit quantizer that represents the analog signal into 2 different levels, each quantized level is assigned a binary value of 1 or 0. In another example, for a 2-bit quantizer that represents the analog signal into 4 different levels, each quantized level is assigned a 2-bit word including 00, 01, 10, or 11.

Thus, each digital value (e.g., binary value or word) generated by the ADC 172 represents a voltage value of the analog electrical signal 130, and the stream of bits or words included in the digital signal 164 generated by the ADC 172 is a digital representation of the electrical signal 130. In other words, the digital signal 164 is a function of the electrical signal 130, and thus, indirectly a function of the stimuli 126 that caused the piezoelectric material 124 to generate the electrical signal 130.

Once a digital signal 164 (e.g., a stream of binary bits or binary words) representing the electrical signal 130 has been generated, the electronic device 120 may be configured to generate a unique encryption key 162 based on the digital signal 164. In one embodiment, the electronic device 120 may select a portion of the digital signal 164 for use as an encryption key 162, wherein the selected portion of the digital signal 164 may include a pre-selected number of bits representing the electrical signal 130. The portion of the digital signal 164 (e.g., the number of bits) selected for use as the encryption key 162 may depend upon an encryption algorithm 160 to be used for encrypting a piece of data 168 based on the encryption key 162. For example, if a particular encryption algorithm 160 is configured to use a 16-bit encryption key, the electronic device 120 may select a 16-bit portion of the digital signal for use as the encryption key 162. In another example, if a particular encryption algorithm 160 is configured to use a 24-bit encryption key, the electronic device 120 may select a 24-bit portion of the digital signal for use as the encryption key 162. Example sizes of the encryption key 162 may include, but not limited to, 8-bit, 16-bit, 32-bit, 64-bit, 128-bit, or 256-bit.

Once the encryption key 162 has been generated, the electronic device 120 may be configured to encrypt data 168 using the generated encryption key 162 to generate encrypted data 170. The encrypted data 170 may be transmitted by the electronic device 120 to another computing node 104 of the computing infrastructure. In one embodiment, the electronic device 120 may be configured to transmit encrypted data 170 in response to receiving a request 110 from another computing node 104 for transmitting a piece of data 168. For example, in response to receiving the request 110 to transmit the piece of data 168, the electronic device 120 may encrypt the requested piece of data 168 using the most recently generated encryption key 162 to generate encrypted data 170. The electronic device 120 may then transmit the encrypted data 170 to the requesting computing node 104. In one embodiment, the electronic device 120 may be configured to separately transmit (e.g., over a secure communication/ transmission channel) to the receiving computing node 104 a copy of the encryption key 162 that was used to encrypt the data 168. The receiving computing node 104 may use the same encryption key 162 received from the electronic device 120 to decrypt the encrypted data 170. This type of encryption is typically referred to as symmetric encryption which involves using a single encryption key 162 to encrypt as well as decrypt data 168.

In other embodiments, asymmetric encryption may be implemented by the electronic device 120. Asymmetric encryption typically includes using a pair of encryption keys 162 for the encryption-decryption process. Typically, a public key is used to encrypt a piece of data. The encrypted data 170 can only be decrypted using a private key that corresponds to the public key that was used to encrypt the data. In this embodiment, the electronic device 120 may be configured to generate a pair of public key and a private key based on a digital signal 164 that represents a particular electrical signal 130. The public encryption key may be used to encrypt a piece of data 168 to generate encrypted data 170 which may be transmitted to a receiver (e.g., another computing node 104). The private key may be separately transmitted (e.g., over a secure channel) to a receiver which may decrypt the encrypted data 170 using the private encryption key.

In certain embodiments, the electronic device 120 may use a machine learning model (ML) 166 to generate an encryption key 162 based on an electrical signal 130. For example, the ML model 166 may be trained to generate encryption keys 162 for several encryption algorithms 160. Once an electrical signal 130 is input to the ML model 166 along with an identification of the particular encryption algorithm 160 to be used, the ML model 166 may generate an encryption key 162 that is compatible and usable with the particular encryption algorithm 160.

FIG. 2 illustrates a flowchart of an example method 200 for encrypting data 168, in accordance with one or more embodiments of the present disclosure. Method 200 may be performed by the electronic device 120 shown in FIG. 1.

At operation 202, electronic device 120 receives a request 110 to transmit a piece of data 168.

As described above, the electronic device 120 may be configured to transmit encrypted data 170 in response to receiving a request 110 from another computing node 104 for transmitting a piece of data 168. For example, in response to receiving the request 110 to transmit the piece of data 168, the electronic device 120 may encrypt the requested piece of data 168 using a most recently generated encryption key 162 to generate encrypted data 170.

At operation 204, the electronic device 120 detects that an electrical signal 130 was generated by the piezoelectric material 124, wherein the electrical signal 130 corresponds to a mechanical stimulus 126 applied to the piezoelectric material 124 and is a function of variations in pressure/stress applied by the mechanical stimulus 126 to the piezoelectric material 124.

As described above, the piezoelectric material 124 coverts stimuli 126 into electrical energy represented as the electrical signal 130. For example, a mechanical stimulus 126 (e.g., mechanical stress, vibrations, movements, shock etc.) as a result of an interaction of the electronic device 120 with its environment (e.g., interaction with a user of the electronic device 120) may cause the piezoelectric material 124 to generate an electrical signal 130. By nature, the electrical signal 130 is a function of the stimuli 126 applied to the piezoelectric material 124. For example, the electrical signal 130 is a function of the mechanical stimulus 126 applied to the piezoelectric material 124. This means that the amount of the mechanical stimulus 126 and frequency with which the mechanical stimulus 126 is applied to the piezoelectric material 124 decides the waveform (e.g., amplitude and frequency) of the electrical signal 130 over time. For example, 0 volts is registered when no mechanical stimulus 126 is applied to the piezoelectric material 124 and a positive voltage is registered when mechanical stimulus 126 is applied. Additionally, larger amounts (e.g., higher intensity) of mechanical stimulus 126 results in higher amplitude peaks for the electrical signal 130.

At operation 206, the electronic device 120 generates an encryption key 162 based on the electrical signal 130 generated by the piezoelectric material 124, wherein the encryption key 162 is a function of the variations in pressure associated with the mechanical stimulus 126 applied to the piezoelectric material 124.

As described above, the electronic device 120 may be configured to generate an encryption key 162 based on an electrical signal 130 generated by the piezoelectric device 122. In one or more embodiments, the electronic device 120 may be configured to convert an electrical signal 130 generated by the piezoelectric device 122 into a digital signal 164. Since the electrical signal 130 is a function of the stimuli 126 applied to the piezoelectric material 124, the digital signal 164 generated based on the electrical signal 130 is indirectly also a function of the stimuli 126 applied to the piezoelectric material 124. As the stimuli 126 applied to the piezoelectric material 124 is usually random depending on random interactions of the electronic device 120 with its environment, the electrical signal 130 which is a function of the stimuli 126 is also random, and the digital signal 164 generated based on the electrical signal 130 is in turn also random. The electronic device 120 may generate an encryption key 162 based on the digital signal 164. Since digital signals 164 generated based on different electrical signals 130 may be random as a result of the respective stimuli 126 applied to the piezoelectric material 124 being random, the encryption key 162 generated based on different digital signals 164 are also different. In other words, encryption keys 162 generated based on different electrical signals 130 generally do not match.

The electronic device 120 may use any known technique to convert the analog electrical signal 130 into a digital signal 164. For example, the electronic device 120 may implement an analog to digital converter (ADC) 172 that converts an analog electrical signal 130 into a digital signal 164 containing a stream of binary digits (e.g., 0s and 1s) that represent the analog electrical signal 130. Like any typical analog to digital converter, the ADC 172 may perform the steps of sampling, quantization and encoding to convert the analog electrical signal 130 into a corresponding digital signal 164. Sampling in an analog-to-digital converter refers to the process of taking samples of a continuous analog signal at specific points in time to convert it into a discrete digital signal. Quantization in an analog-to-digital converter is the process of converting a continuous analog signal into a discrete digital value. During this process, each sampled value is matched with the closest value from a limited number of discrete levels, or quantization levels. The number of quantization levels is determined by the quantization resolution, which is expressed in bits. For example, a 1-bit quantizer can translate the sampled values of the analog signal into 2 different levels, each level represents a particular amplitude value (e.g., voltage) of the signal. For example, a first level may represent 0 volts(V) or near 0V and the second level may represent 5V or near 5V. A 2-bit quantizer can translate the sampled values of the analog signal into 4 different levels, wherein each of the 4 levels represent a distinct amplitude value (e.g., voltage) of the signal. Encoding in analog-to-digital converters is the process of converting quantized signals into a digital representation. This is done by assigning a unique label (e.g., a binary word) to each quantization level. For example, for a 1-bit quantizer that represents the analog signal into 2 different levels, each quantized level is assigned a binary value of 1 or 0. In another example, for a 2-bit quantizer that represents the analog signal into 4 different levels, each quantized level is assigned a 2-bit word including 00, 01, 10, or 11.

Thus, each digital value (e.g., binary value or word) generated by the ADC 172 represents a voltage value of the analog electrical signal 130, and the stream of bits or words included in the digital signal 164 generated by the ADC 172 is a digital representation of the electrical signal 130. In other words, the digital signal 164 is a function of the electrical signal 130, and thus, indirectly a function of the stimuli 126 that caused the piezoelectric material 124 to generate the electrical signal 130.

Once a digital signal 164 (e.g., a stream of binary bits or binary words) representing the electrical signal 130 has been generated, the electronic device 120 may be configured to generate a unique encryption key 162 based on the digital signal 164. In one embodiment, the electronic device 120 may select a portion of the digital signal 164 for use as an encryption key 162, wherein the selected portion of the digital signal 164 may include a pre-selected number of bits representing the electrical signal 130. The portion of the digital signal 164 (e.g., the number of bits) selected for use as the encryption key 162 may depend upon an encryption algorithm 160 to be used for encrypting a piece of data 168 based on the encryption key 162. For example, if a particular encryption algorithm 160 is configured to use a 16-bit encryption key, the electronic device 120 may select a 16-bit portion of the digital signal for use as the encryption key 162. In another example, if a particular encryption algorithm 160 is configured to use a 24-bit encryption key, the electronic device 120 may select a 24-bit portion of the digital signal for use as the encryption key 162. Example sizes of the encryption key 162 may include, but not limited to, 8-bit, 16-bit, 32-bit, 64-bit, 128-bit, or 256-bit.

At operation 208, the electronic device 120 encrypts the requested piece of data 168 to generate encrypted data 170.

At operation 210, the electronic device 120 transmits the encrypted data 170 to a computing node 104 (e.g., the computing node 104 that transmitted the request 110).

As described above, once the encryption key 162 has been generated, the electronic device 120 may be configured to encrypt data 168 using the generated encryption key 162 to generate encrypted data 170. The encrypted data 170 may be transmitted by the electronic device 120 to another computing node 104 of the computing infrastructure. In one embodiment, the electronic device 120 may be configured to transmit encrypted data 170 in response to receiving a request 110 from another computing node 104 for transmitting a piece of data 168. For example, in response to receiving the request 110 to transmit the piece of data 168, the electronic device 120 may encrypt the requested piece of data 168 using the most recently generated encryption key 162 to generate encrypted data 170. The electronic device 120 may then transmit the encrypted data 170 to the requesting computing node 104. In one embodiment, the electronic device 120 may be configured to separately transmit (e.g., over a secure communication channel) to the receiving computing node 104 a copy of the encryption key 162 that was used to encrypt the data 168. The receiving computing node 104 may use the same encryption key 162 received from the electronic device 120 to decrypt the encrypted data 170. This type of encryption is typically referred to as symmetric encryption which involves using a single encryption key 162 to encrypt as well as decrypt data 168.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A system comprising:
a piezoelectric material configured to generate an electrical signal when mechanical stress is applied to the piezoelectric material; and
a processor communicatively coupled to the piezoelectric material and configured to:
receive a request to transmit data;
detect that an electrical signal was generated by the piezoelectric material, wherein the electrical signal corresponds to a mechanical stimulus applied to the piezoelectric material and is a function of variations in pressure applied by the mechanical stimulus to the piezoelectric material;
generate an encryption key based on the electrical signal generated by the piezoelectric material, wherein the encryption key is a function of the variations in pressure associated with the mechanical stimulus;
encrypt the data based on the encryption key to generate encrypted data; and
transmit the encrypted data.

2. The system of claim 1, wherein the mechanical stimulus comprises one or more of vibrations, heat changes, sound waves, or movement.

3. The system of claim 1, wherein the processor is configured to generate the encryption key by:
converting the electrical signal generated by the piezoelectric material into a digital signal, wherein the digital signal comprises a stream binary values or words that represent the electrical signal; and
select at least a portion of the digital signal for use as the encryption key, wherein the selected portion of the digital signal comprises a pre-selected number of bits of the digital signal.

4. The system of claim 1, wherein the processor is configured to transmit over a secure transmission channel, the encryption key to a receiver configured to decrypt the encrypted data.

5. The system of claim 1, wherein the piezoelectric material and the processor are housed inside an electronic device capable of exchanging data with one or more other electronic devices.

6. The system of claim 5, wherein the electrical signal generated by the piezoelectric material is used to at least in part to power the electronic device.

7. The system of claim 1, wherein the piezoelectric material comprises cellulose nanocrystals.

8. A method comprising:
receive a request to transmit data;
detect that an electrical signal was generated by a piezoelectric material configured to generate the electrical signal when mechanical stress is applied to the piezoelectric material, wherein the electrical signal corresponds to a mechanical stimulus applied to the piezoelectric material and is a function of variations in pressure applied by the mechanical stimulus to the piezoelectric material;
generate an encryption key based on the electrical signal generated by the piezoelectric material, wherein the encryption key is a function of the variations in pressure associated with the mechanical stimulus;
encrypt the data based on the encryption key to generate encrypted data; and
transmit the encrypted data.

9. The method of claim 8, wherein the mechanical stimulus comprises one or more of vibrations, heat changes, sound waves, or movement.

10. The method of claim 8, wherein generating the encryption key comprises:
converting the electrical signal generated by the piezoelectric material into a digital signal, wherein the digital signal comprises a stream binary values or words that represent the electrical signal; and
select at least a portion of the digital signal for use as the encryption key, wherein the selected portion of the digital signal comprises a pre-selected number of bits of the digital signal.

11. The method of claim 8, further comprising transmitting over a secure transmission channel, the encryption key to a receiver configured to decrypt the encrypted data.

12. The method of claim 8, wherein the piezoelectric material is housed inside an electronic device capable of exchanging data with one or more other electronic devices.

13. The method of claim 12, wherein the electrical signal generated by the piezoelectric material is used to at least in part to power the electronic device.

14. The method of claim 8, wherein the piezoelectric material comprises cellulose nanocrystals.

15. A non-transitory computer-readable medium storing instructions that when executed by a processor cause the processor to:
receive a request to transmit data;
detect that an electrical signal was generated by a piezoelectric material configured to generate the electrical signal when mechanical stress is applied to the piezoelectric material, wherein the electrical signal corresponds to a mechanical stimulus applied to the piezoelectric material and is a function of variations in pressure applied by the mechanical stimulus to the piezoelectric material;
generate an encryption key based on the electrical signal generated by the piezoelectric material, wherein the encryption key is a function of the variations in pressure associated with the mechanical stimulus;
encrypt the data based on the encryption key to generate encrypted data; and
transmit the encrypted data.

16. The non-transitory computer-readable medium of claim 15, wherein the mechanical stimulus comprises one or more of vibrations, heat changes, sound waves, or movement.

17. The non-transitory computer-readable medium of claim 15, wherein generating the encryption key comprises:
converting the electrical signal generated by the piezoelectric material into a digital signal, wherein the digital signal comprises a stream binary values or words that represent the electrical signal; and
select at least a portion of the digital signal for use as the encryption key, wherein the selected portion of the digital signal comprises a pre-selected number of bits of the digital signal.

18. The non-transitory computer-readable medium of claim 15, wherein the instructions further cause the processor to transmit over a secure transmission channel, the encryption key to a receiver configured to decrypt the encrypted data.

19. The non-transitory computer-readable medium of claim 15, wherein the piezoelectric material and the processor are housed inside an electronic device capable of exchanging data with one or more other electronic devices.

20. The non-transitory computer-readable medium of claim 19, wherein the electrical signal generated by the piezoelectric material is used to at least in part to power the electronic device.
